(19) United States
(12) Patent Application Publication
(10) Pub. No.: US 2013/0070611 A1
(43) Pub. Date: Mar. 21, 2013

(54) APPARATUS AND METHOD FOR REPORTING POWER HEADROOM IN MULTIPLE COMPONENT CARRIER SYSTEM

(71) Applicants: Jae Hyun Ahn, Seoul (KR); Ki Bum Kwon, Seoul (KR); Myung Cheul Jung, Seoul (KR)

(72) Inventors: Jae Hyun Ahn, Seoul (KR); Ki Bum Kwon, Seoul (KR); Myung Cheul Jung, Seoul (KR)

(73) Assignee: PANTECH CO., LTD., Seoul (KR)

(21) Appl. No.: 13/700,004

(22) PCT Filed: Jun. 29, 2011
(86) PCT No.: PCT/KR2011/004749

§ 371 Date: Nov. 26, 2012

(30) Foreign Application Priority Data
Jun. 29, 2010 (KR) 10-2010-0062368

(51) Int. Cl. H04W 52/36

(52) U.S. Cl. CPC H04W 52/365
USPC 370/241; 370/328

(57) ABSTRACT

A method and an apparatus for reporting power headroom by a mobile station in a multiple component carrier system is disclosed. The method includes calculating power headroom values for at least one component carrier configured in the mobile station, receiving information regarding a recommended component carrier selected by a base station among the at least one component carrier configured in the mobile station, selecting at least one report component carrier used to report the calculated power headroom values based on the information regarding the recommended component carrier, and transmitting the calculated power headroom values to the base station through the at least one report component carrier.

### CROSS-REFERENCE TO RELATED APPLICATIONS

This application is the National Stage Entry of International Application PCT/KR2011/004749, filed on Jun. 29, 2011, and claims priority from and the benefit of Korean Patent Application No. 10-2010-0062368, filed on Jun. 29, 2010, which is incorporated herein by reference for all purposes as if fully set forth herein.

### BACKGROUND

1. Field

The present invention relates to radio communication, and more particularly, to an apparatus and a method for reporting power headroom in a multiple component carrier system.

2. Discussion of the Background

As candidates of a next generation radio communication system, 3rd Generation Partnership Project (3GPP) long term evolution (LTE) and Institute of Electrical and Electronics Engineers (IEEE) 802.16m have been developed. The 802.16m standard, which is modified from the existing 802.16e standard, involves two aspects of the continuity of the past and the continuity of the future, which is a standard for the next generation IMT-Advanced system. Therefore, the 802.16m standard satisfies all the advanced requirements for the IMT-Advanced system while maintaining compatibility with a 802.16e standard based Mobile WiMAX system.

A radio communication system generally uses a single bandwidth to transmit data. For example, a second generation radio communication system uses a bandwidth of 200 KHz to 1.25 MHz and a third generation radio communication system uses a bandwidth of 5 MHz to 10 MHz. In order to support the increasing transmission capacity, the latest 3GPP LTE or 802.16m continues to expand its own bandwidth up to 20 MHz or more. In order to increase the transmission capacity, it is essential to increase the bandwidth. However, even when a required level of service is low, supporting a large bandwidth may cause large power consumption.

Therefore, a multiple component carrier system that can define a plurality of carriers having a single bandwidth and a central frequency and transmit and/or receive data in a broadband through the plurality of carriers has been emerged. The multiple component carrier system simultaneously supports a narrowband and a broadband by using one or more carrier. For example, when the single carrier corresponds to a bandwidth of 5 MHz, the multiple component carrier system supports a bandwidth of maximum 20 MHz by using four carriers.

One of methods for allowing a base station to effectively use resources of a mobile station uses power information regarding the mobile station. A power control technology is an essential technology to minimize interference components so as to effectively distribute resources and reduce battery consumption of the mobile station, in radio communication.

However, in the multiple component carrier system, it has not been yet determined whether to transmit power information regarding each component carrier.

### SUMMARY

The present invention provides an apparatus and a method for reporting power headroom in a multiple component carrier system.

The present invention also provides an apparatus and a method for selecting component carriers that are an object of a power headroom report in a multiple component carrier system.

The present invention also provides an apparatus and a method for hierarchically filtering component carriers that are an object of a power headroom report in a multiple component carrier system.

The present invention also provides an apparatus and a method for configuring individual power headroom field for component carriers that are an object of a power headroom report in a multiple component carrier system.

The present invention provides a mobile station apparatus and a method for promoting reliability a power headroom report.

In an aspect, there is provided a method for reporting power headroom by a mobile station in a multiple component carrier system, comprising: calculating power headroom values for at least one component carrier configured in the mobile station, receiving information regarding a recommended component carrier selected by a base station among the at least one component carrier configured in the mobile station, selecting at least one report component carrier used to report the calculated power headroom values based on the information regarding the recommended component carrier, and transmitting the calculated power headroom values to is the base station through the at least one report component carrier.

In another aspect, there is provided a method for receiving power headroom information by a base station in a multiple component carrier system, comprising: selecting, based on a first criterion, at least one recommended component carrier to report a power headroom among a plurality of component carriers configured in a mobile station, transmitting information regarding the selected at least one recommended component carrier to the mobile station, and receiving power headroom values for the plurality of component carriers configured in the mobile station through a component carrier reporting a power headroom, wherein the component carrier reporting the power headroom is extracted by the mobile station based on the information regarding the selected at least one recommended component carrier.

In another aspect, there is provided an apparatus for reporting power headroom in a multiple component carrier system, comprising: a component carrier information receiving unit that receives information regarding a recommended component carrier selected by a base station among at least one configured component carrier, a second component carrier filtering unit that selects at least one component carrier to be used for reporting power headroom based on the information regarding the recommended component carrier, a power headroom value calculation unit that calculates power headroom values for the at least one configured component carrier, and a power headroom field transmitting unit that transmits the calculated power headroom values to the base station through the at least one component carrier selected by the second component carrier filtering unit.

In another aspect, there is provided an apparatus for receiving power headroom in a multiple component carrier system, comprising: a CC filtering unit that selects at least one recommended component carrier among a plurality of component carriers configured in a mobile is station based on a first criterion, an CC information generation unit that generates information regarding the selected at least one recommended component carrier, and a power headroom field receiving unit that receives power headroom values for the plurality of component carriers configured in the mobile station through a component carrier for the power headroom report extracted by the mobile station, based on the information regarding the selected at least one recommended component carrier.

In another aspect, there is provided a method for selecting multiple component carriers transmitting power headroom information, comprising: first filtering extracting at least one recommended component carrier among a plurality of configured component carriers, based on a first criterion, and second filtering extracting at least one component carrier to be used for reporting the power headroom from a set of the at least one recommended component carrier, based on a second criterion. The first criterion and the second criterion perform determination based on whether path losses for each of the plurality of configured component carriers are equal to or larger than a threshold or smaller than the threshold.

As set forth above, since the path loss is too large or the traffic concentration phenomenon occur in the case of the specific component carriers, the exemplary embodiment of the present invention configures the recommended component carrier set information appropriate for the power headroom report so as to be signaled to the mobile station in consideration of the above aspects. The mobile station can more reliably report the power headroom by referring to the information and improve the capabilities of the uplink scheduling of the system.

### BRIEF DESCRIPTION OF THE DRAWINGS

FIG. 1 is a diagram showing a radio communication system.

FIG. 2 is an explanation diagram for explaining intra-band contiguous carrier is aggregation.

FIG. 3 is an explanation diagram for explaining intra-band non-contiguous carrier aggregation.

FIG. 4 is an explanation diagram for explaining inter-band carrier aggregation.

FIG. 5 is a diagram showing an example of protocol architecture for supporting multiple carriers.

FIG. 6 is a diagram showing an example of a frame structure for a multiple carrier operation.

FIG. 7 is a diagram showing a linkage between downlink component carriers and uplink component carriers in a multiple carrier system.

FIG. 8 is a diagram showing an example of a graph showing power headroom on a time-frequency axis.

FIG. 9 is a diagram showing another example of a graph showing power headroom to which an exemplary embodiment of the present invention is applied on a time-frequency axis.

FIG. 10 is a flow chart for explaining a method for reporting power headroom according to an exemplary embodiment of the present invention.

FIG. 11 is a diagram showing a structure of the MAC PDU including a power headroom field according to the exemplary embodiment of the present invention.

FIG. 12 is a flow chart for explaining first Component Carrier (CC) filtering according to an exemplary embodiment of the present invention.

FIG. 13 is a flow chart for explaining second CC filtering according to an exemplary embodiment of the present invention.

FIG. 14 is a flow chart for explaining a process of performing second CC filtering according to an exemplary embodiment of the present invention.

FIG. 15 is a graph showing a power headroom changing process over time.

FIG. 16 is a block diagram showing an apparatus for transmitting a power headroom report and apparatus for receiving a power headroom report according to an exemplary embodiment of the present invention.

FIG. 17 is an explanation diagram for explaining a method for performing secondary filtering using an accumulative number of an HARQ retransmission failure according to an exemplary embodiment of the present invention.

### DETAILED DESCRIPTION OF THE ILLUSTRATED EMBODIMENTS

Hereinafter, exemplary embodiments will be described in detail with reference to the accompanying drawings. In the specification, in adding reference numerals to components throughout the drawings, it is to be noted that like reference numerals designate like components even though components are shown in different drawings. In describing the exemplary embodiments of the present invention, detailed descriptions of well-known functions or constructions are omitted so as not to obscure the description of the present invention with unnecessary detail.

In addition, in describing components of exemplary components of the present invention, terms such as first, second, A, B, (a), (b), etc. can be used. These terms are used only to differentiate the components from other components. Therefore, the nature, times, sequence, etc. of the corresponding components are not limited by these terms. When any components are “connected”, “coupled”, or “linked” to other components, it is to be noted that the components may be directly connected or linked to other components, but the components may be “connected”, “coupled”, or “linked” to other components via another component therebetween.

Further, the present specification describes a radio communication network as an object. An operation performed in the radio communication network may control a network in a system (for example, a base station) supervising corresponding radio communication networks and may be performed during a process of transmitting data or performed in mobile stations coupled with the corresponding radio networks.

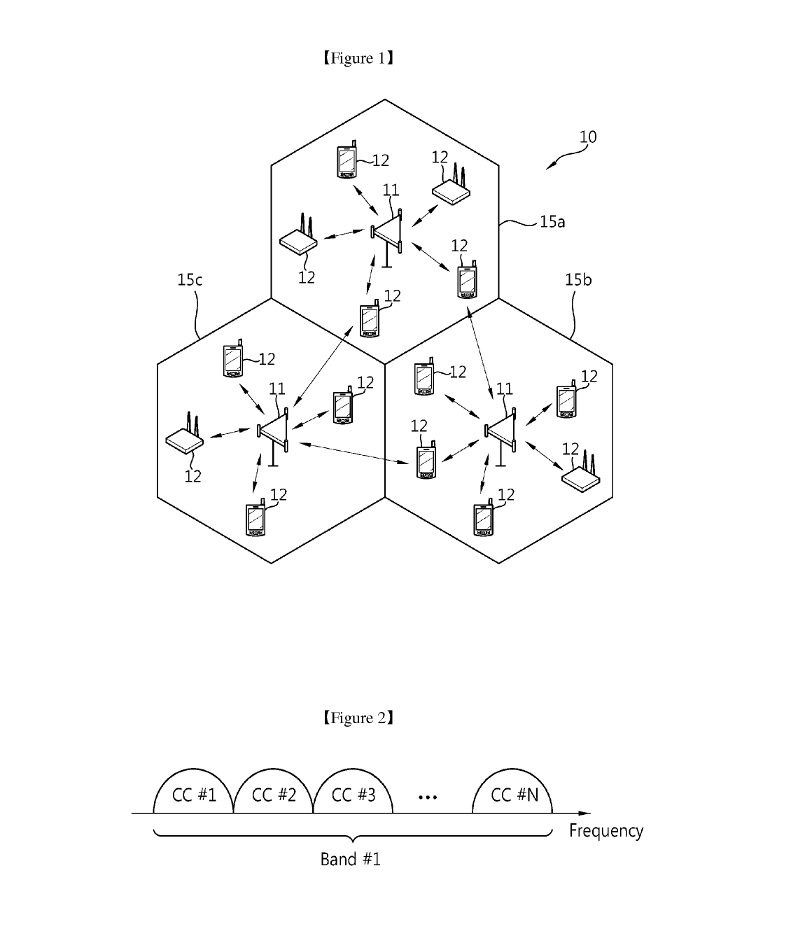

FIG. 1 shows a radio communication system.

Referring to FIG. 1, a radio communication system 10 is widely distributed so as to provide various communication services, such as audio, packet data, or the like.

A radio communication system 10 includes at least one base station (BS) 11. Each base station 11 provides communication services to specific geographical areas (generally referred to as cells) 15a, 15b, and 15c. A cell may again be divided into a plurality of areas (referred to as a sector).

A mobile station (MS) 12 may be fixed or moved and may be referred to as other terms, such as user equipment (UE), a mobile terminal (MT), a user terminal (UT), a subscriber station (SS), a wireless device, personal digital assistant (PDA), a wireless modem, a handheld device, or the like.

The base station 11 is generally referred to as a fixed station communicating with the mobile station 12 and may be referred to as other terms, such as evolved-node B (Enb), a base transcriber system (BTS), an access point, or the like. The cell is to be comprehensively interpreted as some areas are covered by the base station 11 and can include all of the various coverage areas such as a mega cell, a macro cell, a micro cell, a pico cell, a femto cell, or the like.

Hereinafter, a downlink means communication from the base station 11 to the mobile station 12 and an uplink (UL) means communication from the mobile station 12 to the base station 11. At the downlink, a transmitter may be a portion of the base station 11 and a receiver may be a portion of the mobile station 12.

At the uplink, the transmitter may be a portion of the mobile station 12 and the receiver may be a portion of the base station 11.

A multiple access method applied to the radio communication system may be used without limitation. various multiple access methods such as code division multiple access (CDMA), time division multiple access (TDMA), frequency division multiple access (FDMA), orthogonal frequency division multiple access (OFDMA), single carrier-FDMA (SC-FDMA), OFDM-FDMA, OFDM-TDMA, OFDM-CDMA, or the like, may be used. The uplink transmission and the downlink transmission may use a time division duplex (TDD) method that performs transmission at different time or may use a frequency division duplex (FDD) method that performs transmission at different frequencies.

Carrier aggregation (CA) supporting a plurality of carriers is referred to as spectrum aggregation or bandwidth aggregation. An individual unit carrier tied by the carrier aggregation is referred to as component carrier (hereinafter, referred to as CC). Each CC is defined as a bandwidth and a central frequency. The carrier aggregation is introduced to support expanding throughput, prevents the increase in cost due to the introduction of a broadband radio frequency (RF) device, and secure compatibility with the existing systems.

For example, a bandwidth with a maximum of 20 MHz may be supported when five CCs are allocated as granularity in a carrier unit having, for example, a bandwidth of 5 MHz.

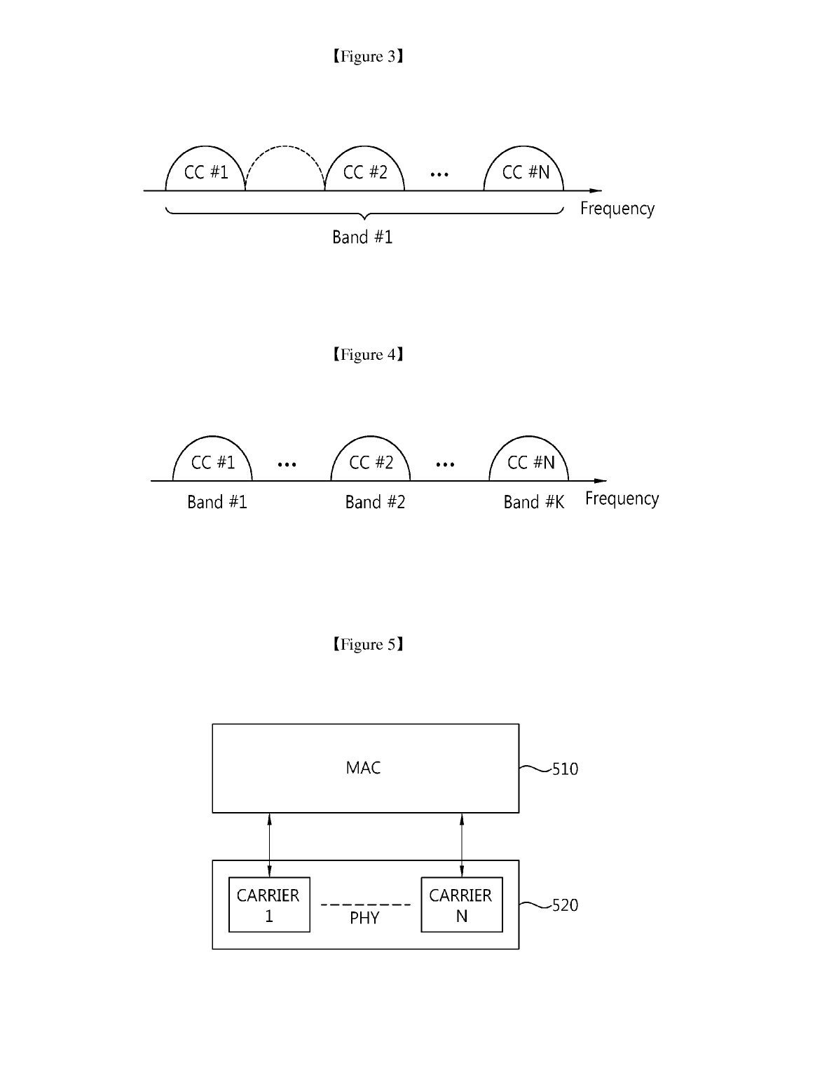

The carrier aggregation may be divided into intra-band contiguous carrier aggregation as shown in FIG. 2, intra-band non-contiguous carrier aggregation as shown in FIG. 3, and inter-band carrier aggregation as shown in FIG. 4.

Referring first to FIG. 2, the intra-band contiguous carrier aggregation is performed between the continuous CCs within the same band. For example, all of CC#1, CC#2, CC#3, . . . , CC#N that are the aggregated CCs are contiguous to each other.

Referring to FIG. 3, the intra-band non-contiguous carrier aggregation is performed between the discontinuous CCs. For example, CC#1 and CC#2 that are the aggregated CCs are spaced apart from each other by a specific frequency.

Referring to FIG. 4, the inter-band carrier aggregation is in a form in which at least one among them is aggregated on different frequency bandwidths when the plurality of CCs are present. For example, CC#1 among the aggregated CCs is present in band#1 and CC#2 is present in band#2.

The number of carriers aggregated between the downlink and the uplink may be set to be different from each other. A case in which the number of downlink CCs is equal to the number of uplink CCs may be referred to as symmetric aggregation and a case in which the number of downlink CCs is different from the number of uplink CC is referred to asymmetric aggregation.

In addition, a size (that is, a bandwidth) of CCs may be different from each other. For example, when five CCs are used to configure of a 70 MHz band, they may be configured, like 5 MHz CC(carrier #0)+20 MHz CC(carrier#1)+20 MHz CC(carrier#2)+20 MHz CC(carrier#3)+5 MHz CC(carrier#4).

Hereinafter, the multiple carrier system is referred to as a system that supports the carrier aggregation. In the multiple carrier system, the contiguous carrier aggregation and/or the non-contiguous carrier aggregation may be used and either of the symmetric aggregation or the non-symmetric aggregation may be used.

FIG. 5 shows an example of protocol architecture for supporting the multiple carriers.

Referring to FIG. 5, a common medium access control (MAC) individual 510 manages a physical layer 520 that uses a plurality of carriers. A MAC management message that is transmitted by a specific carrier may be applied to different carriers. That is, the MAC management message is a message that may control different carriers, including the specific carrier. The physical layer 520 may be operated by time division duplex (TDD) and/or frequency division duplex (FDD).

There are some physical control channels used in the physical layer 520. A physical downlink control channel (PDCCH) that transmits physical control information informs the mobile station of information regarding resource allocation of a paging channel (PCH) and a downlink shared channel (DL-SCH) and hybrid automatic repeat reQuest (HARQ) associated with the DL-SCH. The PDCCH may carry an uplink grant that informs the mobile station of the resource allocation of the uplink transmission.

A physical control format indicator channel (PCFICH) informs the mobile station of the number of OFDM symbols used for the PDCCHs and transmits the number of OFDM symbols for each subframe. A physical hybrid ARQ indicator channel (PHICH) carries HARQ ACK/NAK signals as the response of the uplink transmission. A physical uplink control channel (PUCCH) carries the uplink control information such as HARQ ACK/NAK for downlink transmission, scheduling request, CQI, or the like. A physical uplink shared channel (PUSCH) carries an UpLink shared channel (UL-SCH).

FIG. 6 shows an example of a frame structure for a multiple carrier operation.

Referring to FIG. 6, a radio frame is configured to include 10 subframes. The subframe includes a plurality of OFDM symbols. Each CC may have their own control channels (for example, PDCCH). The CCs may be contiguous to each other or may not be contiguous to each other. The mobile station may support at least one CC according to its own capability.

The CC may be divided into a primary component carrier (hereinafter, referred to as PCC) and a secondary component carrier (hereinafter, referred to as SCC) according to whether the CC is activated. The PCC is a carrier that is activated at all times and the SCC is a carrier that is activated/non-activated according to specific conditions.

The activation means a state in which the transmission or reception of traffic data is performed or is ready. The non-activation means a state in which the transmission or reception of traffic data cannot be performed but the measurement or the transmission/reception of minimum information can be performed.

The mobile station may use only one PCC or at least one SCC together with the PCC. The mobile station may be allocated with the PCC and/or the SCC from the base station. The PCC is a carrier that exchanges main control information between the base station and the mobile station. The SCC may be allocated according to a request of the mobile station or an indication of the base station. The PCC may be used to enter the mobile station into the network and/or allocate the SCC. The PCC may not be fixed to the specific carrier and the carrier configured of the SCC may also be changed into the PCC.

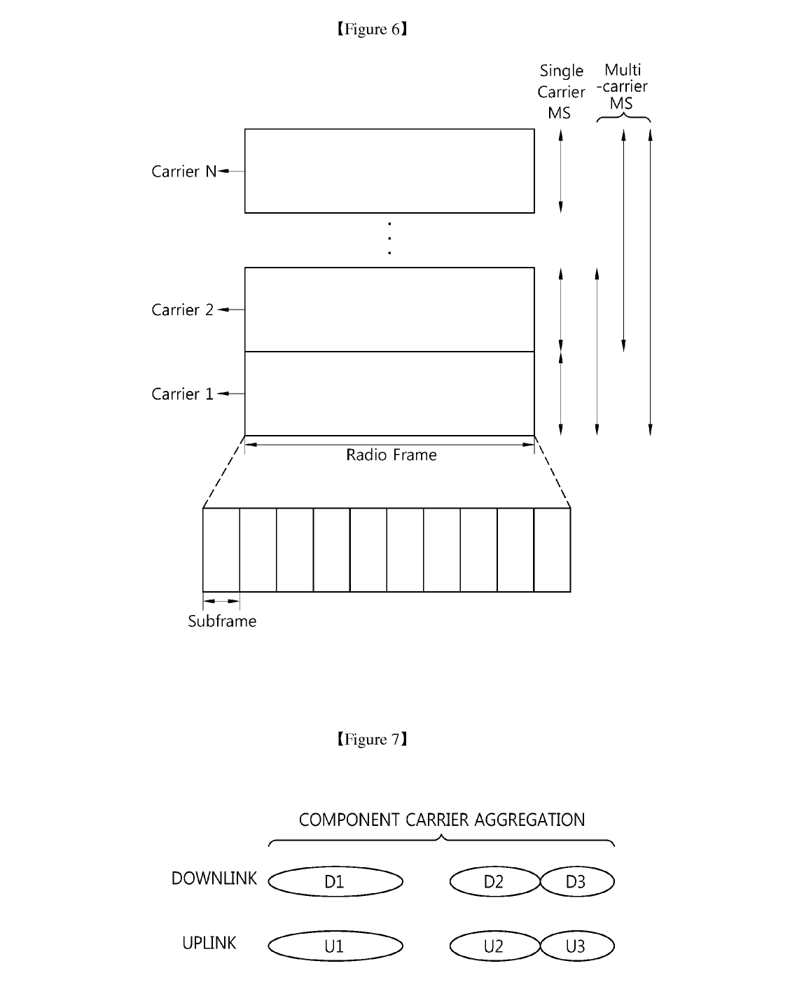

FIG. 7 shows an example of a linkage between downlink component carriers and uplink component carriers in the multiple carrier system.

In the example of FIG. 7, the downlink component carriers (hereinafter, referred to as ‘DL CC’) D1, D2, D3 are aggregated at the downlink and the uplink component carriers (hereinafter, referred to as UL CC) U1, U2, and U3 are aggregated at the uplink. In this case, Di is an index of the DL CC and Ui is an index of the UL CC (i=1, 2, 3). At least one DL CC is the PCC and the rest are the SCC. Similarly, at least one UL CC is the PCC and the rest are the SCC. For example, the D1 and the U1 are the PCC and the D2, U2, D3, and U3 are the SCC.

In the FDD system, the DL CCs are linked with the UL CCs on a one-to-one basis. the D1 and the U1, the D2 and the U2, and the D3 and the U3, respectively, are linked with each other on a one-to-one basis. The mobile station performs the linkage between the DL CCs and the UL CCs through system information transmitted by a logical channel BCCH and mobile station-only RRC messages transmitted by DCCH. Each linkage may be set to be cell specific and may be set to be user equipment specific (UE specific).

An example of the UL CC linked with the DL CC is as follows.

1) The UL CC that allows the mobile station to transmit ACK/NACK information in response to the data transmitted through the DL CC by the base station;

2) The DL CC that allows the base station to transmit ACK/NACK information in response to the data transmitted through the UL CC by the mobile station;

3) The DL CC transmits the response in the case in which the base station receives a random access preamble (RAP) transmitted through the UL CC by the mobile station starting a random access procedure; and

4) The UL CC to which the uplink control information is applied when the base station transmits the uplink control information through the DL CC, or the like.

FIG. 7 shows, by way of example, only the one-to-one linkage between the DL CCs and the UL CCs; however, 1:n or n:1 linkage may also be established. Further, the index of the component carrier does not necessarily correspond to an order of the component carriers or positions of frequency bandwidths of the corresponding component carriers.

Power headroom (PH) will be described below.

It is assumed that the mobile station whose the maximum transmission available power is 10 W uses a frequency bandwidth of 10 Mhz and an output of 9 W. In this case, when the frequency bandwidth of 20 Mhz is allocated to the mobile station, the mobile station requires power of 9 W×2=18 W. However, since the maximum power of the mobile station is 10 W, when 20 MHz is allocated to the mobile station, the mobile station cannot use all the frequency bandwidths or the base station cannot receive signals from the mobile station due to underpower as they are.

Therefore, when the base station knows the power headroom of the mobile station, the base station may allocate appropriate radio resources to the mobile station so that the case in which the transmission from the mobile station is not smoothly performed does not occur as described above. For example, since it is general that data transmitted by the mobile station are unexpectedly generated in response to the characteristics and the amount thereof is not constant, the case in which the mobile station has data to be unexpectedly transmitted to the base station may occur. In this case, the base station may allocate an appropriate amount of radio resources to the mobile station if the base station receives the power headroom report that is received in advance from the mobile station before the generation of data.

Further, since the power headroom is frequently changed, a periodic power headroom report method has been used. According to the periodic power headroom report method, the mobile station triggers the power headroom report when a periodic timer expires and is re-drives the periodic timer when the power headroom is reported.

In addition to this, even when path loss (PL) estimates measured by the mobile station are changed above a predetermined reference value, the power headroom report is triggered. The path loss estimates are measured by the mobile station based on reference symbol received power (RSRP).

The power headroom P_{PH} is defined as a difference between maximum output power Pₘₐₓ configured in the mobile station and power P_{estimated} estimated for the uplink transmission depending on Math FIG. 1 and is represented by dB.

P_{PH}=Pₘₐₓ−P_{estimated}[dB] [Math FIG. 1]

The power headroom PH may be referred to as remaining power or surplus power. That is, at the maximum transmit power of the mobile station configured by the base station, the rest of the values other than the P_{estimated} that is a sum of the transmit power used in each component carrier become the P_{PH} value.

As an example, there may be the case that the P_{estimated} is equal to the power P_{PUSCH} estimated about the transmission of the physical uplink shared channel(PUCCH). In this case, the P_{PH} may be obtained depending on Math FIG. 2.

P_{PH}=Pₘₐₓ−P_{PUSCH}[dB] [Math FIG. 2]

As another example, there may be the case in which the P_{estimated} is equal to the sum of the power P_{PUSCH} estimated for the transmission of the PUSCH and the power P_{PUCCH} estimated for the transmission of the PUCCH (physical uplink control channel). In this case, the P_{PH} may be obtained depending on Math FIG. 3.

P_{PH}=Pₘₐₓ−P_{PUCCH}−P_{PUSCH}[dB] [Math FIG. 3]

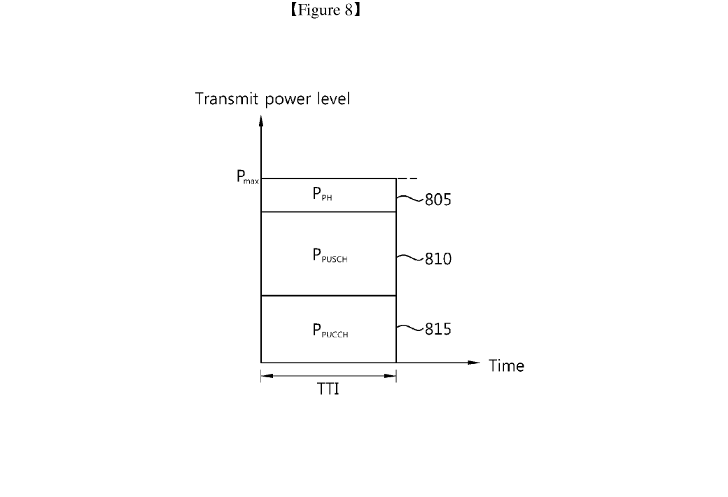

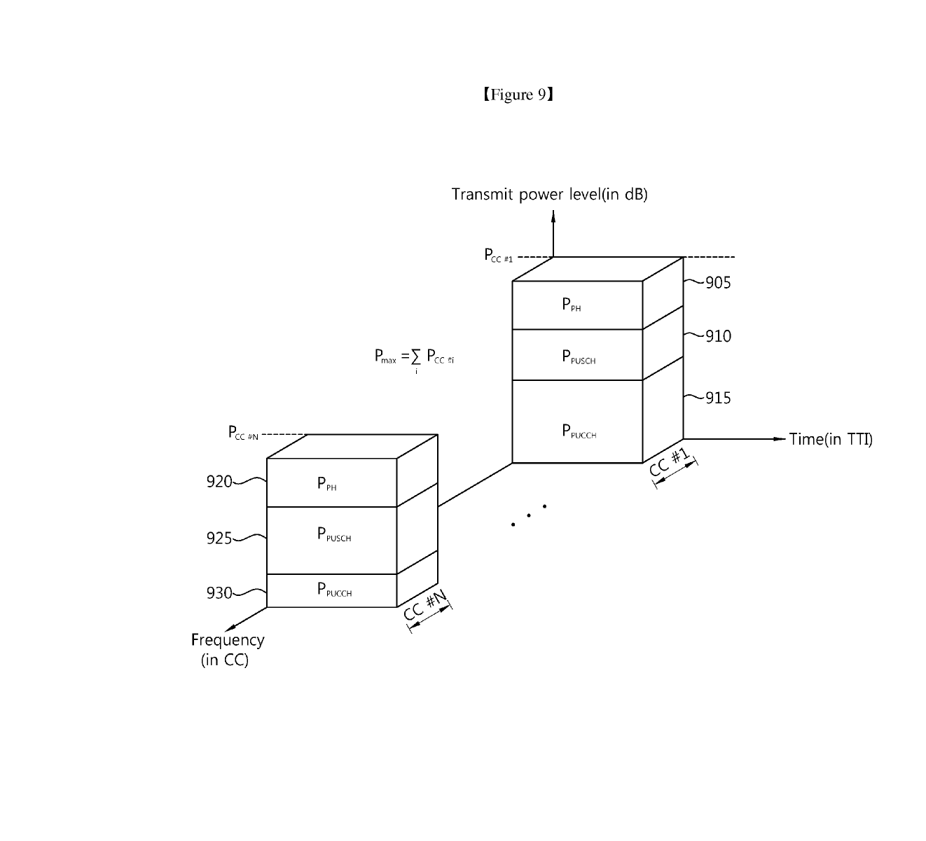

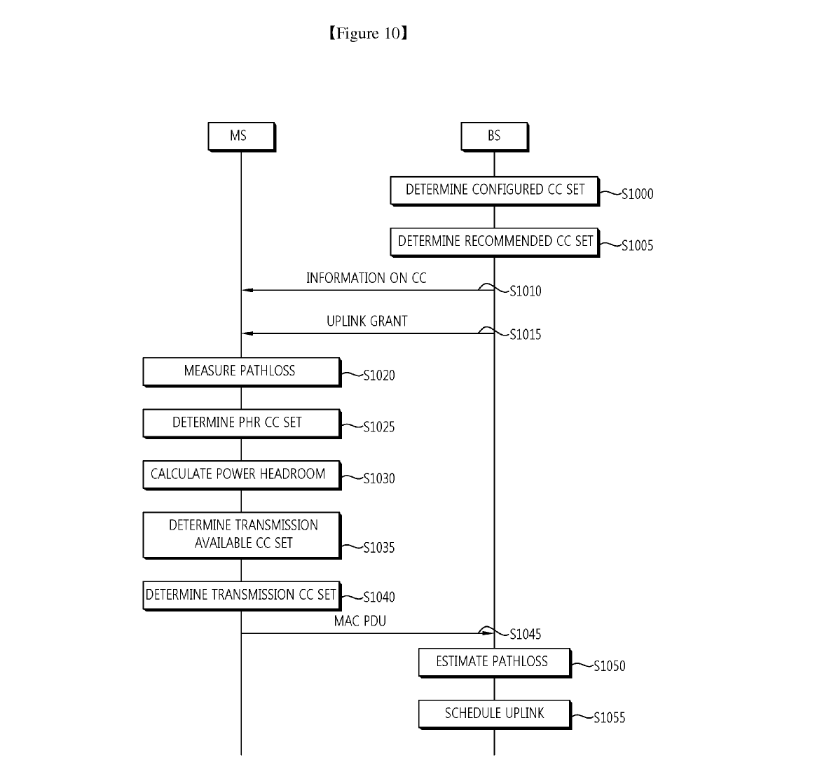

FIG. 8 shows the P_{PH} according to Math FIG. 3 that is represented by a graph on a time-frequency axis. This represents the P_{PH} for a single CC.

Referring to FIG. 8, maximum output power Pₘₐₓ configured in the mobile station is configured to include P_{PH} 805, P_{PUSCH} 810, and P_{PUCCH} 815. That is, at the Pₘₐₓ, the rest of the power headroom other than the P_{PUSCH} 810 and the P_{PUCCH} 815 is defined as the P_{PH} 805. Each power is calculated in each transmission time interval (TTI) unit.

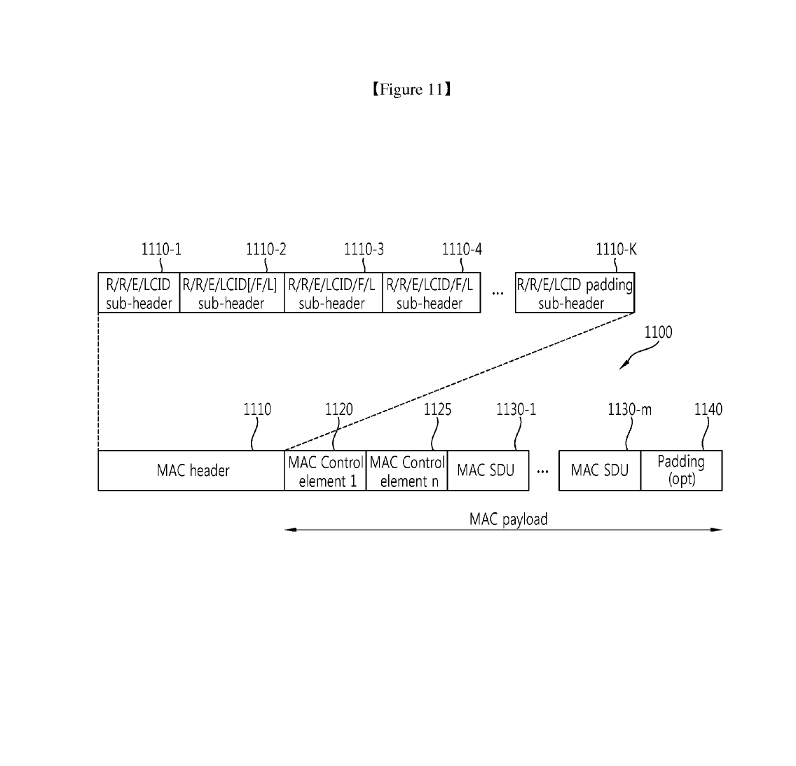

The power headroom for the plurality of configured CCs may be individually defined in the multiple component carrier system, which is represented by a graph on the time-frequency axis as shown in FIG. 9. FIG. 9 shows the case in which the Pestimated in the above Math FIG. 1 is equal to a sum of the power P_{PUSCH} estimated in regards to the transmission of the PUSCH and the power P_{PUCCH} estimated in regards to the transmission of the PUCCH.

Referring to FIG. 9, the maximum output power Pₘₐₓ configured in the mobile station is equal to the sum of the maximum output power P_{CC#1}, P_{CC#2}, . . . , P_{CC#N} for each CC#1, CC#2, . . . , CC#N. The generalization of maximum output power for each CC depends on the following Math FIG. 4.

$${P}_{CCi} = {P}_{max} - {\sum }_{j \neq i} {P}_{CCi} \qquad [ Math Figure 4 ]$$

Assuming that P_{CC#1}=P_{CC #2}= . . . =P_{CC #N}=PCC, P_{PH} 905 of CC #1 is equal to P_{CC}-P_{PUSCH} 910-P_{PUCCH} 915 and P_{PH} 920 of CC #n is equal to P_{CC}-P_{PUSCH} 925-P_{PUCCH} 930. The maximum output power (P_{CC}) level for each CC is constantly defined and the P_{PH}, P_{PUSCH}, and P_{PUCCH} may be present with different ratios for each CC. That is, the power ratio for each CC may be allocated differently.

The power headroom field (PH field), which is an information field representing a power headroom value, may have a size of 6 bits as an example. Table 1 shows a power headroom field table representing the power headroom field and the power headroom value.

TABLE 1

| PH field | Power Headroom Level | Measured Quantity Value(dB) |
|---|---|---|
| 0 | Power Headroom_0 | −23 ≦ P_{PH} ≦ −22 |
| 1 | Power Headroom_1 | −22 ≦ P_{PH} ≦ −21 |
| 2 | Power Headroom_2 | −21 ≦ P_{PH} ≦ −20 |
| 3 | Power Headroom_3 | −20 ≦ P_{PH} ≦ −19 |
| . . . | . . . | . . . |
| 60 | Power Headroom_60 | 37 ≦ P_{PH} ≦ 38 |
| 61 | Power Headroom_61 | 38 ≦ P_{PH} ≦ 39 |
| 62 | Power Headroom_62 | 39 ≦ P_{PH} ≦ 40 |
| 63 | Power Headroom_63 | P_{PH} ≧ 40 |

Referring to Table 1, the power headroom value is included in the range between −23 dB and +40 dB. When the power headroom field is 6 bits, 2⁶=64 indexes may be represented. The power headroom value may be divided into a total of 64 levels. For example, when the power headroom field is 0 (that is, 000000 when represented by 6 bits), the power headroom value of the specific CC represents −23≦P_{PH}≦−22 dB.

The plurality of UL CC may have different path losses according to a system deployment scenario and a difference between frequency bandwidths. The mobile station necessarily performs the power headroom reports for each CC so as to perform the correct power control of the uplink. Two problems are largely caused when the plurality of power headroom reports are performed. The above problems are the increase in overhead and the degradation in reliability due to the power headroom report.

The overhead due to the power headroom reports for the plurality of CCs is increased in proportion to the number of CCs. For example, when the power headroom field is 6 bits and the configured CCs are five in total, 5 CCs×6 bits/CC=30 bits are required. When the power headroom field is included in a medium access control (MAC) protocol data unit (PDU), a MAC subheader including an R field, an E field, an LCID field, or the like and the R field on a MAC payload, or the like, are additionally required so as to transmit the power headroom field. Therefore, the number of bits actually required for the power headroom reports for all the CCs is two times or more the number of bits of the power headroom field, which may be served as the overhead. In this case, the R field is a field representing the remaining extra fields and the E field is a field representing whether the additional LCID field is present in the subheader Further, the L field is a field representing a length of MAC SDU or variable-size MAC control element in a byte unit and the F field is a field representing a size of the L field.

The problem of the reliability of the power headroom report is due to diversity of the CCs to which the power headroom is reported. Each CC undergoes the capabilities and traffic situations of different links. When the capabilities of the link are poor, it is highly likely to fail the power headroom report through the corresponding CCs. Further, when the traffic is is concentrated to the specific CC, the power headroom report through the specific CC drops out of priority and thus, has a high possibility of delay.

Since the carrier aggregation is a technology introduced to transmit high-capacity data at high speed, a need exists for a method for reducing the amount of resources consumed and improving the reliability of the power headroom report.

To this end, the exemplary embodiment of the present invention provides a method for transmitting power headroom information by using only the CCs selected based on a predetermined criterion among all the configured CCs.

First, terms used throughout the present specification may include a configured CC set, a recommended CC set, a PHR CC set, a transmission available CC set, a transmit CC set, or the like.

The configured CC set is a set of the CCs configured to the mobile station from the base station so as to aggregate carriers. The configured CC set is changed according to the capabilities of the mobile station.

The recommended CC set is a set of CCs selected by the base station, which is appropriately used to report the power headroom among the CCs of the configured CC set.

The power headroom report CC set (PHR CC set) is a set of CCs that is an object of a calculation of a power headroom value. The mobile station may transmit only the power headroom value for CCs belonging to the PHR CC set. That is, the PHR CC set is a set of CCs that is an object of the power headroom value report (PHR).

The PH transmission available CC set is a set of CCs determined to be appropriately used to report the power headroom for the specific CC by the mobile station.

The PH transmission CC set is a set of CCs selected to be used so as to report the is actual power headroom by the scheduling of the mobile station.

Hereinafter, a method for transmitting power headroom will be described based on the above-mentioned terms.

FIG. 10 is a flow chart for explaining a method for reporting power headroom according to an exemplary embodiment of the present invention.

Referring to FIG. 10, the base station determines the configured CC set for the mobile station (S1000). The mobile station may simultaneously receive at least one CC according to the given capabilities. Therefore, the base station may configure at least one CC according to the capabilities of the mobile station. For example, in the case in which the overall CCs given in the system are five in total, that is, CC1, CC2, CC3, CC4, and CC5, all the CCs may be configured and some CCs such as CC1, CC2, and CC3 may be configured, according to the capabilities and channel situations of each mobile station. The set of CCs specifically configured in the mobile station among the overall CCs of the system given as described above is referred to as a configured CC set.

The base station determines the recommended CC set (S1005). The recommended CC set is a set of CCs selected by the base station from the configured CC set according to the predetermined criterion. In other words, the recommended CC set is a set of CC determined by the base station when the mobile station is appropriate to report the power headroom. A process of determining the recommended CC set from the configured CC set by the base station is referred to as first CC filtering. An object of configuring the recommended CC set is to allow the base station to recommend candidate CCs to be used in reporting the power headroom to the mobile station.

However, the CCs included in the recommended CC set are only the candidates to is be used in reporting the power headroom and therefore, the mobile station does not necessarily report the power headroom through the CCs of the recommended CC set. As a result, the mobile station first considers the recommended CC set as the candidates but may not perform the power headroom report through the specific CCs determined to be inappropriate in some cases. That is, in the exemplary embodiment of the present invention, both of the recommended CC set and the PHR CC set are associated with CCs that are a transfer subject of the MAC PDU, among the CCs defined to report the power headroom. Therefore, it is not that the non-selected CCs do not necessarily perform the power headroom report.

Therefore, the recommended CC set may include all the configured CCs and may include some CCs. That is, the recommended CC set is a subset of the configured CC set. For example, when the configured CC set is {CC1, CC2, CC3, CC4, CC5}, the recommended CC set may be configured of a subset of the configured CC set such as {CC1}, {CC1, CC3, CC4}, or the like.

The base station transmits information on CC to the mobile station (S1010). The information on CC includes at least one of report mode information, configured CC set information, and recommended CC set information. In addition, the information on CC may include at least one of the configured CC set information and the recommended CC set information together with the report mode information.

The report mode information is information defining whether the mobile station reports the power headroom for all the CCs of the configured CC set or reports the power headroom for the CCs of the recommended CC set. For example, the report mode is the power headroom reports for all the CCs of the configured CC set when the report mode information is 1 and the report mode is the power headroom reports for the CCs belonging to the recommended CC set when the report mode information is 0. In this case, when the report mode information 1, the information on CC includes the configured CC set information. When the report mode information 0, the information on CC includes the configured CC set information and the recommended CC set information. As described above, when the report mode information is used, it may determine whether or not the recommended set information is included in the information on CC, thereby reducing the number of bits of the information on CC.

As another example, the information on CC may include the configured CC set information and the recommended CC set information. In this case, when the recommended CC set information is identical with the configured CC set information, it may indicate that all the configured CCs are included in the recommended CC set. In this case, it does not require to separately transmit the report mode information.

The configured CC set information is indication information indicating the configured CC set and the recommended CC set information is indication information indicating the recommended CC set. The mobile station configures the CCs based on the configured CC set information and uses the CCs selected in consideration of the recommended CC set among the configured CCs to report the power headroom for all or a part of the CCs configured in the mobile station. The information on CC may be an RRC message that is generated from a radio resource control (RRC) layer.

The base station transmits uplink grant to the mobile station (S1015). The uplink grant, which is downlink control information (DCI) of format 0 for allocating the uplink resources to the mobile station, is transmitted to a physical downlink control channel (PDCCH). The uplink grant is configured as the following Table 2.

TABLE 2

| - | Flag for format0/format1A differentiation - 1 bit, where value 0 indicates format 0 and | |
|---|---|---|
| | value 1 indicates format 1A | |
| - | Frequency hopping flag - 1 bit | |
| - | Resource block assignment and hopping resource allocation - | |
| | ┌log₂(N_{RB}^{UL}(N_{RB}^{UL} +1)/2┐ bits | |
| | - | For PUSCH hopping: |

| | |
|---|---|
| - | N_{UL}_{_{—}}ₕₒₚ MSB bits are used to obtain the value of ñ_{PRB}(i) |
| - | (┌log₂(N_{RB}^{UL}(N_{RB}^{UL} +1)/2)┐ −N_{UL}_{_{—}}ₕₒₚ) bits provide the resource allocation |
| | of the first slot in the UL subframe |

| | |
|---|---|
| - | For non-hopping PUSCH: |

| | |
|---|---|
| - | (┌log₂(N_{RB}^{UL}(N_{RB}^{UL} +1)/2)┐) bits provide the resource allocation in the UL |
| | subframe |

| | |
|---|---|
| - | Modulation and coding scheme and redundancy version - 5 bits |
| - | New data indicator - 1 bit |
| - | TPC command for scheduled PUSCH - 2 bits |
| - | Cyclic shift for DM RS - 3 bits |
| - | UL index - 2 bits (this field is present only for TDD operation with uplink downlink |
| | configuration 0) |
| - | Downlink Assignment Index (DAI) - 2 bits (this field is present only for TDD |
| | operation with uplink-downlink configurations 1-6) |
| - | CQI request - 1 bit |
| - | Carrier Index Field (CIF) - 3 bits(this field is present only for Carrier Aggregation) |

The mobile station uses the uplink resources allocated by the uplink grant to perform the power headroom report.

The mobile station measures a Pathloss of the configured CC set (S1020). In the multiple component carrier system to which the exemplary embodiment of the present invention is applied, the data transmission of the uplink is performed through the uplink common channel. In this case, one of factors required to allow the mobile station to determine the transmit power of the uplink common channel is a path loss estimate. The estimates are measured by the mobile station depending on Math FIG. 5 based on the reference symbol received power (RSRP).

PL_{UE}_{_{—}}ₑₛₜᵢₘₐₜₑ=P_{BS-TX}−RSRP_{avg}[dB] [Math FIG. 5]

PLUE_estimate is the Pathloss estimated by the mobile station, PBS_TX is a power value of a reference signal to be theoretically received, RSRPavg is a power value of the reference signal actually received by the mobile station.

The mobile station confirms the CCs calculating the power headroom value. In this case, the mobile station can confirm at least one CC calculating the power headroom value. As an example, the mobile station determines the PHR CC set, i.e., a set of CCs that calculates the power headroom value, i.e., that is an object of the power headroom report (PHR) (S1025). The PHR CC set may be a subset of the configured CC set. Therefore, the mobile station transmits only the power headroom value for the CCs belonging to the PHR CC set without transmitting the power headroom value for all the CCs belonging to the configured CC set, thereby reducing the overhead consumed to report the power headroom.

The mobile station calculates the power headroom value for the CCs belonging to the PHR CC set (S1030). The mobile station determines the uplink transmit power depending on Math FIG. 6 by using an allocated bandwidth (BW), a modulation and coding scheme (MCS), and the path loss estimate.

P_{estimated}=PL_{UE-estimate}+CINR_{MCS})×BW [Math FIG. 6]

Where CINRMCS means a target carrier to interference and noise ratio (CINR) [dB/Hz] according to an MCS level and is represented by power density per subcarrier. This is a valued defined by upper layer signaling between the base station and the mobile station. NI is the power density of noise and interference and is measured by the base station through the uplink. BW is a magnitude [Hz] of a frequency domain on a radio resource allocated to the mobile station. The power headroom value may be obtained by the above Math FIGS. 1 to 3 based on the uplink transmit power and the maximum transmit power.

In this case, a step of determining the PHR CC set may be performed after a step of calculating the power headroom value. The mobile station calculates the power headroom value for all the CCs configured in consideration of the measured Pathloss and may be then determined the PHR transmission set by confirming the CCs that may be an object of the PHR transmission. Even in this case, the PHR CC set is a set of CCs that is an object of the calculation of the power headroom value and an object of the report of the power headroom value (PHR) as described above. Therefore, an order of the step of calculating the power headroom value and the step of determining the PHR CC set is not limited to the exemplary embodiment of the present invention.

Thereafter, the mobile station selects the CCs determined to be appropriate to perform the power headroom report from the recommended CC set as the candidate CC to be used in transmitting the power headroom report, based on the predetermined criterion (S1035). The set of CCs selected to be appropriately used to report the power headroom is referred to as a transmission available CC set. A process of determining the transmission available CC set from the recommended CC set by the mobile station is referred to as second CC filtering. An example of arranging a type of CC sets may include a case as shown in the following Table 3.

TABLE 3

| | | | Transmission |
|---|---|---|---|
| Case | Configured CC Set | Recommended CC set | Available CC Set |
| 1 | {CC1, CC2, CC3, | {CC1, CC3, CC5} | {CC1, CC3} |
| | CC4, CC5} | | |
| 2 | {CC1, CC2, CC3, | {CC1, CC2, CC3, | {CC2, CC3} |
| | CC4} | CC4} | |

Referring to Table 3, Case 1 corresponds to a case in which the recommended CC set becomes {CC1, CC3, CC5} other than CC2 and CC4 through the first CC filtering by the base station under the case in which the configured CC set is {CC1, CC2, CC3, CC4, CC5}. If the mobile station is determined that only the CC5 of the recommended CC set is inappropriate for the power headroom report, the CC5 is filtered and the CC1 and CC3 are defined as the transmission available CC set, thereby reporting the power headroom through the CC1 and/or the CC3.

In Case 2, the base station informs the mobile station of the recommended CC set {CC1, CC2, CC3, CC4} under the case in which the configured CC set is {CC1, CC2, CC3, CC4}. That is, Case 2 is a case in which the configured CC set is equal to the recommended CC set. The mobile station may determine that the CC1 and the CC4 of the recommended CC set are inappropriate for the power headroom report and may report the power headroom through the CC2 and/or the CC3 belonging to the transmission available CC set by the second CC filtering.

As described above, all the CCs configured in the mobile station are not used to report the power headroom and only some CCs are selected as the candidate CCs to be used in reporting the final power headroom by the hierarchical filtering of the base station and the mobile station. When the power headroom is reported by selecting only some CCs in which the channel state is very good, the reliability of the power headroom report may be increased, as compared with when the power headroom is reported through the CCs in which the channel state is poor.

The mobile station determines the transmission CC set by its own scheduling (S1040). The transmission CC set is a subset of the transmission available CC set. That is, all the CCs belonging to the transmission CC set are not used to report the power headroom and only the finally selected CCs are used to report the power headroom by a scheduler of the mobile station.

Table 4 shows an example of the configured CC set, the recommended CC set, the PHR CC set, the transmission available CC set, and the transmission CC set.

TABLE 4

| | | | Transmission | |
|---|---|---|---|---|
| Configured | Recommended | | Available | Transmission |
| CC Set | CC set | PHR CC set | CC set | CC Set |
| {CC1, CC2, | {CC2, CC3, | {CC1, CC3, | {CC2, CC3, | {CC2, CC3} |
| CC3, CC4, | CC4, CC5} | CC4, CC5} | CC5} | |
| CC5} | | | | |

Referring to FIG. 4, the base station first configures the CC1, CC2, CC3, CC3, CC4, and CC5 to be used for carrier aggregation as the configured CC set in the mobile station and informs the mobile station of the configured CC set. In this case, the base station selects the CCs appropriately used to report the power headroom of the configured CC set as the recommended CC set {CC2, CC3, CC4, CC5}. Therefore, the CC1 among CCs of the configured CC set is excluded from the recommended CC set.

In this case, the mobile station determines the PHR CC set calculating the power headroom value as the {CC1, CC3, CC4, CC5}. Therefore, the mobile station calculates the power headroom value for each of CC1, CC3, CC4, and CC5. The mobile station determines the set of CCs that may transmit the power headroom value for each of the calculated CC1, CC3, CC4, and CC5, that is, the transmission available CC set. In the case of Table 4, the mobile station configures the rest CCs excluding the CC4 from the recommended CC set as the transmission available CC set {CC2, CC3, CC5}.

Thereafter, the CC5 is finally excluded from the transmission available CC set by the scheduler of the mobile station, only the CC2 and CC3 are determined as the final transmission CC set, the power headroom values for each CC of the calculated PHR CC set {CC1, CC3, CC4, CC5} using the CC2 and/or the CC3 are transmitted.

In this case, the CC serving to report the power headroom does not necessarily transmit the power headroom value for the CC and may transmit the power headroom values for is other CCs. For example, the mobile station may transmit the power headroom values for the calculated CC1 and CC3 through the CC2 and may transmit the power headroom values for the calculated CC4 and CC5 through the CC3.

When the power headroom report is triggered, the mobile station configures the power headroom field for the transmission CC set and transmits the MAC PDU including the configured power headroom field to the base station (S1045). The power headroom report may be triggered periodically.

According to the periodic power headroom report method, the mobile station triggers the power headroom report when a periodic timer expires and re-drives the periodic timer when the power headroom is reported. In addition to this, even when path loss estimates measured by the mobile station are changed above a predetermined reference value, the power headroom report is triggered.

Meanwhile, the MAC PDU is transmitted using the uplink resources allocated by the uplink grant. The power headroom field may be determined by the above Table 1.

The structure of the MAC PDU including the power headroom field may be described with reference to FIG. 11.

Referring to FIG. 11, a MAC PDU 1100 includes a MAC header 1110, at least one MAC control element 1120, . . . , 1125, at least one MAC service data units (MAC SDUs) 1130-1, . . . 0.1130-m, and padding 1140. The MAC control elements 1120 and 1125 are control messages generated by the MAC layer. When the MAC control elements 1120, . . . , 1125 include the power headroom field, the MAC control elements 1020, . . . , 1025 are referred to as the power headroom MAC control element.

The MAC SDUs 1130-1, . . . , 1130-m correspond to RLC PDUs that are transmitted is from a radio link control (RLC) layer. The padding 1140 is a predetermined number of bits that is added so as to make the size of the MAC PDU constant. The MAC control elements 1120, . . . , 1125, the MAC SDUs 1130-1, . . . , 1130-m, and the padding 1140 are collectively referred to as the MAC payload.

The MAC header 1111 includes at least one sub-header 1110-1, 1110-2, . . . , 1110-k and each subheader 1110-1, 1110-2, . . . , 1110-k corresponds to a single MAC SDU, a single MAC control element, or the padding. An order of the subheaders 1110-1, 1110-2, . . . , 1110-k is arranged to be identical with an order of the corresponding MAC SDU, MAC control element, or paddings within the MAC PDU 1100.

Each subheader 1110-1, 1110-2, . . . , 1110-k may include four fields such as R, R, E, and LCID or six fields such as R, R, E, LCID, F, and L. The subheader including four fields is a subheader corresponding to the MAC control element or the padding and the subheader including six fields is a subheader corresponding to the MAC SDU.

The logical channel ID (LCID) field, which is an identification field identifying the logical channel corresponding to the MAC SDU or the type of the MAC control element or the padding, may be 5 bits. For example, the LCID field identifies that the corresponding MAC control element is the power headroom MAC control element to transmit the power headroom. This is shown in Table 5.

TABLE 5

| Index | LCID values |
|---|---|
| 00000 | CCCH |
| 00001-01010 | Identity of the logical channel |
| 01011-11000 | Reserved |
| 11001 | Reference CC Indicator |
| 11010 | Power Headroom Report |
| 11011 | C-RNTI |
| 11100 | Truncated BSR |
| 11101 | Short BSR |
| 11110 | Long BSR |
| 11111 | Padding |

Referring to FIG. 5, an LCID field value of 11001 indicates that the corresponding MAC control elements 1120, . . . , 1125 are the MAC control elements to transmit the reference CC indication information.

Meanwhile, the power headroom value to be reported by the base station is not necessarily transmitted through the CC having the power headroom value. For example, the power headroom value for the CC1 may be transmitted through the CC2. In this case, the mobile station transmits a power headroom indicator indicating whether the power headroom value is for any CC to the base station.

The power headroom indicator, which is a bitmap format, may indicate whether the power headroom for any CC is reported. Each bit corresponds to a single CC. When the power headroom indicator is set to be 1, it indicates that the power headroom for the corresponding CC is transmitted and when the power headroom indicator is set to be 0, it indicates that the power headroom for the corresponding CC is not transmitted.

For example, it is assumed that a total of five CCs, that is, CC1, CC2, CC3, CC4, and CC5 are configured in the mobile station. When the power headroom indicator is 01001, is only the bits corresponding to CC#2 and CC#5 are set to be 1, such that the power headroom indicator indicates that the power headroom value for {CC2, CC5} is transmitted. The power headroom indicator may be included in the MAC PDU. In particular, the power headroom indicator may be included in the LCID field or the MAC control element.

Referring back to FIG. 10, the base station reversely estimates the Pathloss of the mobile station depending on Math FIG. 7 by using the bandwidth allocated to the mobile station, the CINR according to the MCS level, the transmit power estimated by the mobile station, the NI value (S1050).

P_{estimated}=PL_{UE-estimate}+CINR_{MCS}+NI)*BW[dBm] [Math FIG. 7]

As described above, in Math FIG. 7, the Pestimated, which is the estimated uplink transmit power, may be calculated from the maximum transmit power and the power headroom value of the mobile station depending on Math FIG. 1. The PLUE-estimated is the Pathloss estimated by the mobile station. The CINRMCS indicates the CINR according to the MCS level. The NI is the power density of the noise and the interference. The BW is a magnitude [Hz] of a frequency domain on the radio resources allocated to the mobile station.

The base station performs the uplink scheduling based on the Pathloss estimated by the base station (S1055).

The exemplary embodiment of the present invention configures the recommended component carrier set information appropriate for the power headroom report so as to be signaled to the mobile station, in consideration of the case in which the path loss is too large or the traffic concentration phenomenon occur in the case of the specific component carriers, thereby increasing the reliability of the power headroom report. That is, the exemplary embodiment of is the present invention performs the reliable power headroom report using the minimum resources, thereby improving the capabilities of the uplink scheduling of the system.

Hereinafter, the first CC filtering by the base station and the second CC filtering by the mobile station will be described above.

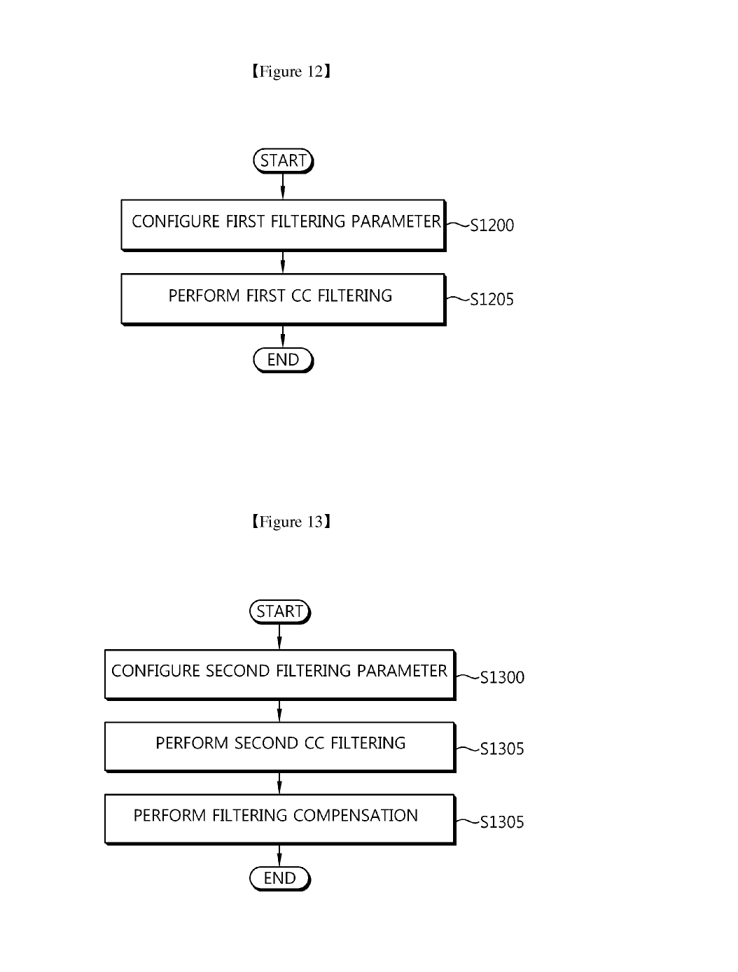

FIG. 12 is a flow chart for explaining the first CC filtering according to the exemplary embodiment of the present invention. FIG. 12 shows that the base station is a process of determining the recommended CC set from the configured CC set.

Referring to FIG. 12, the base station configures a first filtering parameter (S1200). The first filtering parameter includes at least one of the Pathloss, the carrier to interference and noise ratio (CINR), and traffic load.

The base station performs the first CC filtering for all the CCs of the configured CC set based on the first filtering parameter (S1205).

As an example, a method for performing the first CC filtering based on the Pathloss is as follows. When the Pathloss for CC estimated through the power headroom report of the mobile station is smaller than the defined threshold, the base station includes the CC in the recommended CC set. On the other hand, when the Pathloss is equal to or larger than the threshold, the base station excludes the CCs from the recommended CC set.

For example, it is assumed that the configured CC set is {CC1, CC2, CC3, CC4, CC5} and each of the pathlosses estimated for each CC of the configured CC set {CC1, CC2, CC3, CC4, CC5} is 5 dB, 10 dB, 8 dB, 12 dB, 3 dB and the threshold is 7 dB. In this case, according to the first CC filtering, the recommended CC set is determined as the {CC1, CC5} having the Pathloss smaller than the threshold 7 dB.

In this case, the threshold may be changed according to sensitivity of a receiving is end of the base station and may be defined among values of 100 dB or less. As the threshold is small, the CCs having better channel state will be determined as the recommended CC set. Therefore, the base station may include the CC in the desired channel state in the recommended CC set by controlling the threshold.

As another example, a method for performing the first CC filtering based on the CINR is as follows. In this case, when the CINR of the CC is equal or larger than the defined threshold, the base station may include the CC in the recommended CC set. On the other hand, when the CINR of the CC is smaller than the defined threshold, the base station may exclude the CC from the recommended CC set. The threshold may be a value above the required least CINR value required to decode the minimum MCS level defined in the standard. The threshold may have a difference according to the capabilities of a decoder of the receiving end of the base station, for example, may be defined among values of −2 dB or more. As the threshold is large, it is highly likely to include the CCs having better channel state in the recommended CC set.

As another example, a method for performing the first CC filtering based on the traffic load is as follows. For example, when the traffic load of the CC is smaller than the defined threshold, the base station may include the CC in the recommended CC set. When the traffic load of the CC is equal to or larger than the defined threshold, the base station may exclude the CC from the recommended CC set. The threshold may be set to about 80% of the processable maximum traffic load.

The detailed Pathloss, CINR, and traffic load proposed as the threshold in the above-mentioned description are only an example for describing the present invention and each threshold may be changed according to the implementations.

When the recommended CC set is determined by the first CC filtering, the base is station transmits the recommended CC set information to the mobile station and the mobile station again determines the transmission available CC set finally reporting the power headroom by the second CC filtering. Hereinafter, the second CC filtering is described.

FIG. 13 is a flow chart for explaining the second CC filtering according to the exemplary embodiment of the present invention. FIG. 13 shows that the mobile station is a process of determining the transmission available CC set from the configured CC set.

Referring to FIG. 13, the mobile station configures a second filtering parameter (S1300). The second filtering parameter includes at least one of the Pathloss and an accumulative number of hybrid automatic repeat reQuest (HARQ) retransmission failure.

The mobile station performs the second CC filtering for all the CCs of the recommended CC set based on the second filtering parameter (S1305). The second CC filtering may be performed by applying both of the Pathloss and the accumulative number of hybrid automatic repeat reQuest (HARQ) retransmission failure and only any one thereof.

As an example, a method for performing the second CC filtering based on the Pathloss is as follows. When the Pathloss for the CC is equal to or larger than the threshold according to the sudden change in the path loss, the mobile station determines that it is inappropriate to perform the power headroom report to the CC, thereby excluding the corresponding CC from the transmission available CC set. On the other hand, the Pathloss for the CC is smaller than the threshold, the mobile station may include the corresponding CC in the transmission available CC set. The threshold may be changed according to the sensitivity of the receiving end of the base station and may be defined at values of 100 dB or less. As the threshold is small, it is likely to include the CCs having better channel state in the transmission available CC set.

As another example, a method for performing the second CC filtering based on the accumulative number of HARQ retransmission failure is as follows. The HARQ retransmission failure occurs when not acknowledgement (NACK) is transmitted as much as a maximum number of retransmission from the base station at the time of uplink HARQ transmission or acknowledgement (ACK) does not arrive from the base station for a predetermined time.

For example, the base station transmits NACK in response to the transmission of data to the base station from the mobile station and in response thereto, the mobile station retransmits the data. Further, when the repeat of the transmission of NACK from the base station is generated as many as the maximum number of retransmission, the mobile station declares the HARQ retransmission failure.

What the HARQ retransmission failure is consecutively continued for the specific CC may be the case in which the radio link error for the specific CC currently occurs or the degradation in capabilities due to the increases in interference occurs. Therefore, it is inappropriate to report the power headroom to the specific CC. The reason is that the power headroom report may not be smoothly performed.

When the accumulative number of HARQ retransmission failure for the specific CC is generated by the threshold at the determination time of the transmission available CC set, the mobile station may exclude the specific CC from the transmission available CC set. On the other hand, when the HARQ retransmission failure for the specific CC does not occur at the time of the determination time of the transmission available CC set or the accumulative number of HARQ retransmission failure is smaller than the threshold, the mobile station may include the specific CC in the transmission available CC set. For example, the threshold may be about three times the maximum number of HARQ retransmission, which may be changed according to the is implementation method.

As a result of performing the second CC filtering, when there is no CC included in the transmission available CC set, the mobile station performs filtering compensation that includes the CC having the lowest Pathloss among the recommended CC set in the transmission available CC set (S1310).

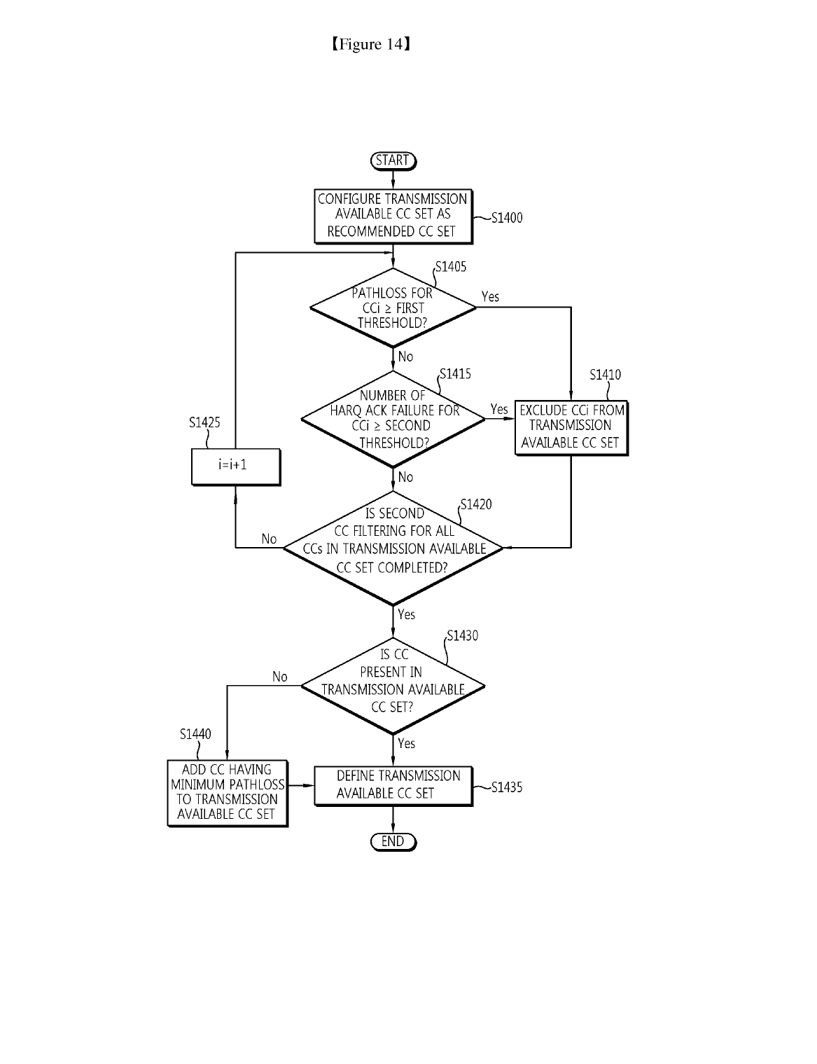

FIG. 14 is a flow chart for explaining a process of performing the second CC filtering of the mobile station according to the exemplary embodiment of the present invention.

Referring to FIG. 14, the mobile station first configures the transmission available CC set so as to be equal to the recommended CC set (S1400). The mobile station compares the Pathlosses for each CC belonging to the transmission available CC set with a first threshold (S1405). The first threshold is a predetermined Pathloss configured for the second filtering. When the Pathloss of CCi (1≦I≦N, N is the number of CCs configuring the recommended CC set) is equal to or larger than the first threshold, the mobile station excludes the CCi from the transmission available CC set (S1410).

At step S1405, if the Pathloss of CCi is smaller than the first threshold, the mobile station compares the accumulative number of HARQ ACK failure for the CCi with a second threshold (S1415). The second threshold is a predetermined reference accumulative number of HARQ ACK failure configured for the second filtering. When the accumulative number of HARQ ACK failure for the CCi is equal to or larger than the second threshold, the mobile station excludes the CCi from the transmission available CC set (S1410). At step S1415, when the accumulative number of HARQ ACK failure for the CCi is smaller than the second threshold, the mobile station determines whether the second CC filtering for all the CCs belonging to the transmission available CC set completes (S1420) and if it is determined that the second CC is filtering does not complete, the second CC filtering for CC (i+1) is performed (S1425, S1405).

At step S1420, if it is determined that the second CC filtering for all the transmission available CC sets completes, the mobile station determines whether the CC is present in the current transmission available CC set (S1430). If It is determined that at least one CC is included in the transmission available CC set, the mobile station determines that the transmission available CC set is the final transmission available CC set (S1435). Meanwhile, when there is no CC in the transmission available CC set after step S1420, the mobile station adds the CC having the least Pathloss in the recommended CC set to the transmission available CC set, which may be performed in the scheduler of the mobile station (S1440).

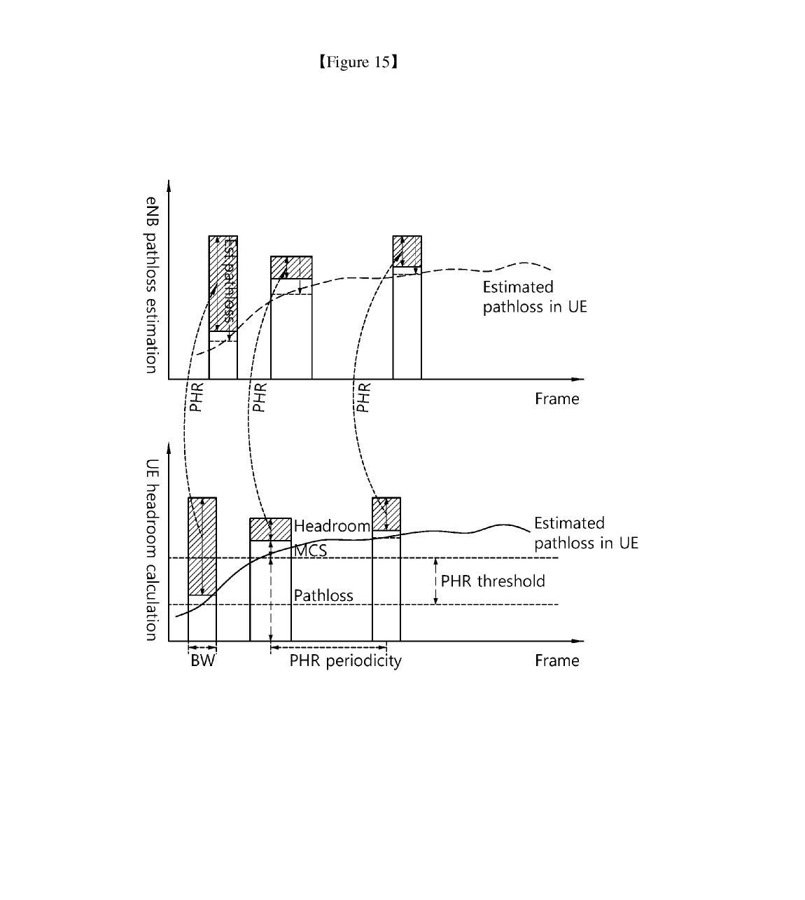

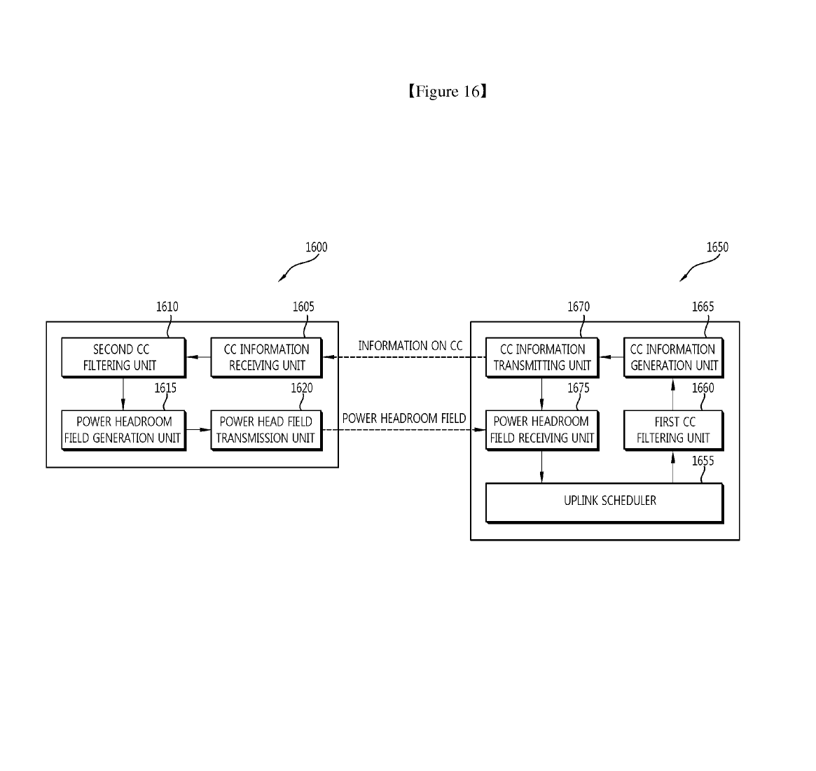

FIG. 15 is a graph showing a process of changing the power headroom over time.

Referring to FIG. 15, a horizontal axis of the graph shows a flow of time and a vertical axis thereof shows power density per subcarrier. Each square area means maximum transmission power Pmax. When a bandwidth BW allocated is increased at a predetermined maximum transmit power, the power density per subcarrier is weak. That is, a height of a square is small. A shaded portion within each square shows the power headroom. The rest portion in which the power headroom is subtracted from the maximum transmit power becomes the transmit power of the mobile station at the corresponding frame. The transmit power of the mobile station is configured to include a portion in which the path loss is compensated and a portion in which the MCS level is compensated.

FIG. 15 shows only the frame portion in which the power headroom report is triggered and transmitted. The base station may estimate the path loss for next scheduling by using the power headroom value transmitted through the uplink, as described with reference to Math FIG. 7. As shown in FIG. 15, the Pathloss is estimated by using allocated bandwidth and is the MCS level of the corresponding frame, the power headroom, and the maximum transmit power of the mobile station. The power headroom value transmitted by the mobile station is delayed by some frames until the power headroom value reaches the base station. The reason is due to the processing time until the base station allocates the resources and the mobile station transmits data in response to the corresponding indication.

In order to correctly estimate the path loss, two triggering conditions of generating the power headroom report are defined. As one triggering condition, a period for receiving the power headroom report through a predetermined period may be designated and the power headroom report per the corresponding period may be generated. As the other triggering condition, the threshold for a difference value of the path loss may be designated so as to sense the sudden change in the path loss within the defined period and the power headroom report may be generated when the path loss exceeding the corresponding threshold is generated. In FIG. 15, the reason why the power headroom report is generated even when the interval between the first power headroom report and the second power headroom report is shorter than the period is that the triggering through the threshold is generated according to the sudden change in the path loss. Although not shown in FIG. 15, a prohibit timer is defined so as to prevent the power headroom report from being frequently generated according to the two conditions. After the power headroom is reported, the power headroom report may not be triggered within the prohibit timer.

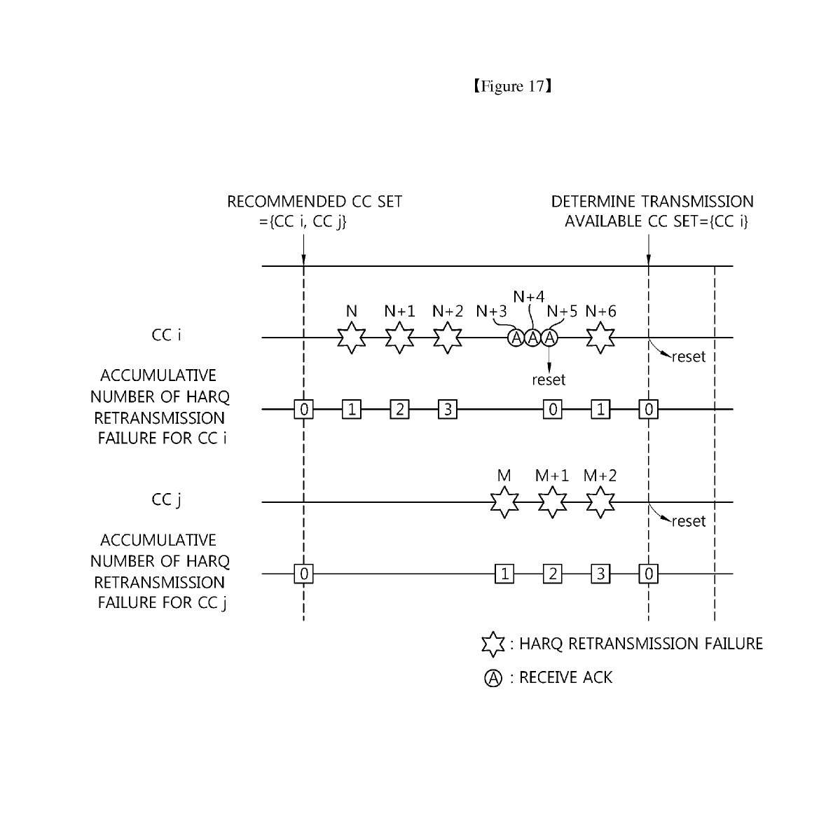

FIG. 16 is a block diagram showing an apparatus for transmitting a power headroom report and an apparatus for receiving a power headroom report according to the exemplary embodiment of the present invention. As described with reference to FIG. 1, the apparatus for transmitting (power headroom) may be the mobile station or a part of the mobile station and the apparatus for receiving (power headroom) may be the base station or a part of the is base station.

Referring to FIG. 16, an apparatus 1600 for transmitting a power headroom report includes cc information receiving unit 1605, a second CC filtering unit 1610, a power headroom field generation unit 1615, and a power headroom field transmission unit 1620.

The information on CC receiving unit 1605 receives the information on CC from an apparatus 1650 for receiving a power headroom report. The information on CC includes at least one of the report mode information, the configured CC set information, and the recommended CC set information. The report mode information is information about whether the mobile station reports the power headroom through all the CCs of the configured CC set or reports the power headroom through the CCs of the recommended CC set. The configured CC set information is indication information indicating the configured CC set and the recommended CC set information is indication information indicating the recommended CC set. The information on CC receiving unit 1605 further receives the uplink grant according to the uplink scheduling from the receiving apparatus 1650.

The second CC filtering unit 1610 selects only the CCs determined to be appropriate to perform the power headroom report from the recommended CC set using the second filtering parameter other than the CCs determined to be inappropriate to perform the power headroom report therefrom, thereby performing the second CC filtering configuring the transmission available CC set. An example of the second CC filtering performed by the second CC filtering unit 1620 is shown in FIG. 14.

The power headroom field generation unit 1615 calculates the power headroom for each CC configured based on the maximum transmit power of the mobile station and the power estimated for the uplink transmission. A method for calculating the power headroom depends on is the above Math FIGS. 1 to 6 and step S1025 of FIG. 10. The power headroom field generation unit 1615 generates the power headroom field necessary to report the power headroom reports for each CC. The structure of the generated power headroom field is included in the MAC PDU as described in FIG. 11 and is determined by referring to a power headroom field table of Table 1.

For example, when the generated power headroom field is included in the MAC control element, the MAC subheader corresponding to the MAC control element includes the LCID field. The LCID field is generated by referring to the LCID field table of Table 4. The MAC PDU may include the power headroom indicator indicating whether the generated power headroom field is for any CC.

The power headroom field transmitting unit 1620 transmits the generated power headroom field to the apparatus 1650 for receiving a power headroom report through each CC belonging to the transmission available CC set. The CC actually transmitting the power headroom field in the transmission available CC set configures the transmission CC set.

Meanwhile, the apparatus 1650 for receiving a power headroom report includes an uplink scheduler 1655, a first CC filtering unit 1660, an CC information generation unit 1665, an CC information transmitting unit 1670, and a power headroom field receiving unit 1675.

The uplink scheduler 1655 performs the uplink scheduling by using the power headroom value received from the apparatus 1600 for transmitting a power headroom report. As a result of the uplink scheduling, the uplink grant is transmitted.

The first CC filtering unit 1660 performs the first CC filtering determining the recommended CC set from the configured CC set. The first CC filtering unit 1660 extracts the recommended CC set from the configured CC set based on the first filtering parameter such as is the Pathloss, the CINR, and the traffic load as shown in FIG. 12.

The CC information generation unit 1665 generates the information on CC associated with the CC set such as the configured CC set information and the recommended CC set information. The CC information generation unit 1665, which is the element of the RRC layer, may generate the information on CC as the RRC message.

The CC information transmitting unit 1670 transmits the information on CC to the apparatus 1600 for transmitting a power headroom report.

The power headroom receiving unit 1675 receives the power headroom field from the apparatus 1600 for transmitting a power headroom report.

FIG. 17 is an explanation diagram for explaining a method for performing secondary filtering using the accumulative number of HARQ retransmission failure according to the exemplary embodiment of the present invention.

Referring to FIG. 17, it is assumed that the HARQ transmission is performed in the CCi and the CCj (1≦i, j≦N, N is the number of CCs configuring the recommended CC set) belonging to the recommended CC set. As an example, among the filtering parameter determining the transmission available CC set, it is assumed that the accumulative number of HARQ retransmission failure is 3. Further, when NACK is generated three times according to the HARQ retransmission, this is considered as the HARQ retransmission failure. In this case, the accumulative number of HARQ retransmission failure and the maximum retransmission number according the HARQ transmission may be variably set in consideration of the reliability and speed of the transmitted packet data.

First, the mobile station determines whether the determination time of the transmission available CC set arrives. If it is determined that the determination time of the is transmission available CC set arrives, the mobile station resets the accumulative number of HARQ retransmission failure for all the recommended CCs to 0.

Thereafter, the mobile station receives the recommended CC set including the CCi and the CCj from the base station. That is, the mobile station determines whether the HARQ retransmission failure for CCi and CCj, and each CC among the received recommended CC set occurs.

As an example, the mobile station confirms whether the HARQ retransmission failure for N-th packet occurs at the CCi. In this case, if it is determined that the HARQ retransmission failure occurs, the mobile station increases the accumulative number of HARQ retransmission failure of the CCi by 1. That is, the accumulative number of HARQ retransmission failure for the CCi is counted as 1. Thereafter, the mobile station confirms that the HARQ retransmission failure for N+1 and N+2 packets consecutively occurs counts the accumulative number of HARQ retransmission failure as 3.

However, the mobile station sequentially receiving ACK for N+3, N+4, and N+5 packets from the base station is reset the accumulative number of HARQ retransmission failure counted as 3 is reset to 0. That is, when the HARQ retransmission failure for the CCi does not occur, the mobile station determines whether the ACK is received by the defined number at the CCi from the base station. If the ACK is received, the mobile station increases an ACK counter for the specific CC by 1. The mobile station compares the ACK counter with a predetermined number. If the ACK counter is equal to or larger than the predetermined number, the mobile station may reset the ACK counter for the CCi and the accumulative number of HARQ retransmission failure to 0.

Thereafter, when the HARQ retransmission failure for N+6 packet occurs, the is mobile station counts the accumulative number of HARQ retransmission failure as 1.

In this case, when the determination time of the transmission available CC set arrives, the accumulative number of HARQ retransmission failure for CCi is 1, such that the mobile station maintains the CCi without excluding the CCi from the transmission available CC set.

Meanwhile, the mobile station confirming that the HARQ retransmission failure for three packets M, M+1, and M+2 at CCj consecutively occurs counts the accumulative number of HARQ retransmission failure as 3. Thereafter, since the mobile station is confirmed that the accumulative number of HARQ retransmission failure is counted as 3 at the determination time of the transmission available CC set, the mobile station excludes the CCj from the transmission available CC set.

Therefore, the mobile station may confirm that the transmission available set is {CCi} by referring to the case in which the recommended CC set received from the base station is {CCi, CCj} but according to a result of performing the second filtering based on the HARQ retransmission failure.

Further, the mobile station confirming the final transmission available CC set may initialize the accumulative number of HARQ retransmission failure at the corresponding CC belonging to the recommended CC set to 0. This is to allow the mobile station to determine the belonging to the transmission available CC set at the next period, which is to initialize the filtering operation of the recommended CC set.

As described above, the mobile station obtains the accumulative number of HARQ retransmission failure for each CC and increases the accumulative number for each HARQ retransmission failure by 1 and may reset the accumulative number for HARQ retransmission is failure to 0 at the time when the ACK is consecutively received by a predetermined number from the base station or the determination time of the transmission available CC set. In this case, when the accumulative number of HARQ retransmission failure is used, the mobile station may determine the transmission available CC set having the reliability appropriate to use the power headroom report.

The component carrier may be defined as a concept of the downlink component carrier or both of the downlink component carrier and the uplink component carrier and may be defined as a cell. In other words, the cell may also be defined as only the DL frequency resource (for example, component carrier) where the radio signal recognizable by the mobile station may reach the predetermined area and may be defined as a pair of UL frequency resources from the mobile station capable of receiving the signals from the base station to the base station through the DL frequency resources and the DL frequency.

The spirit of the present invention has been just exemplified. It will be appreciated by those skilled in the art that various modifications, changes, and substitutions can be made without departing from the essential characteristics of the present invention. Accordingly, the embodiments disclosed in the present invention and the accompanying drawings are used not to limit but to describe the spirit of the present invention. The scope of the present invention is not limited only to the embodiments and the accompanying drawings. The protection scope of the present invention must be analyzed by the appended claims and it should be analyzed that all spirits within a scope equivalent thereto are included in the appended claims of the present invention.

1. A method for reporting power headroom by a mobile station in a multiple component carrier system, comprising:
calculating power headroom values for at least one component carrier configured in the mobile station;
receiving information regarding a recommended component carrier selected by a base station among the at least one component carrier configured in the mobile station;
selecting at least one report component carrier used to report the calculated power headroom values based on the information regarding the recommended component carrier; and
transmitting the calculated power headroom values to the base station through the at least one report component carrier.

2. The method of claim 1, wherein the information regarding the recommended component carrier is information regarding a set including at least one component carrier, and
the set includes at least one component carrier selected by the base station based on at least one of pathloss, carrier to interference and noise ratio (CINR), and traffic load.

3. The method of claim 2, wherein the set of the recommended component carrier is configured of component carriers of which the pathloss is smaller than a threshold.

4. The method of claim 2, wherein the set of the recommended component carrier is configured of component carriers of which the CINR is equal to or larger than a threshold.

5. The method of claim 2, wherein the set of the recommended component carrier is configured of component carriers of which the traffic load is smaller than a threshold.

6. The method of claim 1, wherein a pathloss of the at least one report component carrier is smaller than a threshold.

7. The method of claim 1, wherein selecting the at least one report component carrier further comprises:
selecting component carriers of which an accumulative number of hybrid automatic repeat reQuest (HARQ) retransmission failure of specific component carriers has values smaller than a configured threshold, wherein the accumulative number is included in the information regarding the recommended component carriers.

8. A method for receiving power headroom information by a base station in a multiple component carrier system, comprising:
selecting, based on a first criterion, at least one recommended component carrier to report a power headroom among a plurality of component carriers configured in a mobile station;
transmitting information regarding the selected at least one recommended component carrier to the mobile station; and
receiving power headroom values for the plurality of component carriers configured in the mobile station through a component carrier reporting a power headroom, wherein the component carrier reporting the power headroom is extracted by the mobile station based on the information regarding the selected at least one recommended component carrier.

9. An apparatus for reporting power headroom in a multiple component carrier system, comprising:
a component carrier information receiving unit that receives information regarding a recommended component carrier selected by a base station among at least one configured component carrier;
a second component carrier filtering unit that selects at least one component carrier to be used for reporting power headroom based on the information regarding the recommended component carrier;
a power headroom value calculation unit that calculates power headroom values for the at least one configured component carrier; and
a power headroom field transmitting unit that transmits the calculated power headroom values to the base station through the at least one component carrier selected by the second component carrier filtering unit.

10. An apparatus for receiving power headroom in a multiple component carrier system, comprising:
a Component Carrier (CC) filtering unit that selects at least one recommended component carrier among a plurality of component carriers configured in a mobile station, based on a first criterion;
an CC information generation unit that generates information regarding the selected at least one recommended component carrier; and
a power headroom field receiving unit that receives power headroom values for the plurality of component carriers configured in the mobile station through a component carrier for the power headroom report extracted by the mobile station, based on the information regarding the selected at least one recommended component carrier.

11. A method for selecting multiple component carriers transmitting power headroom information, comprising:
first filtering extracting at least one recommended component carrier among a plurality of configured component carriers, based on a first criterion; and
second filtering extracting at least one component carrier to be used for reporting the power headroom from a set of the at least one recommended component carrier, based on a second criterion,
wherein the first criterion and the second criterion perform determination based on whether path losses for each of the plurality of configured component carriers are equal to or larger than a threshold or smaller than the threshold.

12. The method of claim 1, wherein the receiving the information regarding the recommended component carriers further comprises:
receiving report mode information for the power headroom values and information regarding the at least one component carrier configured in the mobile station,
wherein one of the report mode information, the information regarding the at least one component carrier configured in the mobile station, and the information regarding the recommended component carrier is received through a radio resource control (RRC) message.
